(19) United States
(12) Patent Application Publication
(10) Pub. No.: US 2008/0043641 A1
(43) Pub. Date: Feb. 21, 2008

(54) Method and apparatus for emergency remote video monitoring

(75) Inventors: Brian B. Wilson, San Antonio, TX (US); John Anthony McClenny, San Antonio, CA (US); Thomas Scott Webster, San Antonio, TX (US); Roger A. Cockroll, San Antonio, TX (US); Steven M. Wollmershauser, San Antonio, TX (US)

Correspondence Address: G. Michael Roebuck, PC, FROST BANK BUILDING, 6750 WEST LOOP SOUTH, SUITE 920, BELLAIRE, TX, 77401, US

(73) Assignee: SBC Knowledge Ventures L.P., Reno, NV (US)

(21) Appl. No.: 11/496,379

(22) Filed: Jul. 31, 2006

(51) Int. Cl. H04L 12/16; H04Q 11/00

(52) U.S. Cl. 370/259

(57) ABSTRACT

A method is disclosed for sending video data over an internet protocol (IPTV) network. The method includes receiving an emergency call from a remote client IPTV device over the IPTV network at a video monitoring system (VMS), receiving over the IPTV network at VMS video data from a video camera at the remote client, locating a mobile video device (MVD) proximate of the remote client and sending the video data to the MVD.

### FIELD OF THE DISCLOSURE

The present disclosure relates to an emergency telephone call response system.

### BACKGROUND

Many security systems include multiple video cameras, motion detectors, heat sensors, as well as various door and window traps that have been placed in a building structure by a security company or security system vendor. Such a building structure may include, but is in no way limited to, houses, apartment buildings, hotels, office buildings, and stores. The video cameras, motion detectors, heat sensors, and door and window traps, which may be referred to generally as “security equipment”, may be monitored by personnel of the security company who are located at a central station.

That is, as shown in the example of a security system may include security equipment, which may include video cameras, motion detectors, heat sensors and door and window traps that are disposed throughout a building structure, which may include either of a residence or a place of business. The present description will refer to a residence, though there are very minor differences, if any, between a security system for a residence and any of the other exemplary building structures mentioned above, and therefore the terms may be used interchangeably for the purposes of the present disclosure.

### BRIEF DESCRIPTION OF THE DRAWINGS

FIG. 1 is a schematic diagram of an illustrative embodiment showing an internet protocol television (IPTV) system distributing video from a residence through a video monitoring system (VMS) to a mobile video audio device (MVAD);

FIG. 2 is a schematic diagram of a data structure for storing data in an illustrative embodiment;

FIG. 3 is a flow chart of functions performed in an illustrative embodiment; and

FIG. 4 is a diagrammatic representation of a machine in the form of a computer system within which a set of instructions, when executed, may cause the machine to perform any one or more of the methodologies of the illustrative embodiment.

### DETAILED DESCRIPTION

In view of the above, an illustrative embodiment is presented through one or more of its various aspects to provide one or more advantages, such as those noted below.

In a particular embodiment a method for sending video data over an internet protocol (IPTV) network is disclosed. The method includes receiving an emergency call including but not limited to a “911” call, from a remote client IPTV device over the IPTV network at a video monitoring system (VMS), receiving over the IPTV network at the VMS video data from video camera at the remote client, locating a mobile video device (MVD) proximate to the remote client and sending the video data to the MVD.

In another aspect of a particular embodiment wherein the emergency call is a 911 call. In another aspect of a particular embodiment the method further includes receiving an IP address for the video camera, accepting video control commands for the video camera from emergency personnel associated with the MVD at the VMS and sending data indicating the video control commands to the IP address for the video camera.

In another aspect of a particular embodiment the method further includes sending video data from the MVD to the remote client through the VMS. In another aspect of a particular embodiment the method wherein the MVD further comprises a mobile video audio device (MVAD), the method further includes establishing audio communication between the remote client and emergency personnel associated with the MVAD through the VMS.

In another particular embodiment a method for receiving video data over an internet protocol (IPTV) network is disclosed. The method includes receiving an emergency call from a remote client IPTV device through the IPTV network at mobile video device (MVD) and receiving video data from the video camera to the MVD. In another aspect of a particular embodiment the method further includes receiving an IP address for a video camera from a video monitoring system (VMS) at the remote client and sending video control commands data from the MVD through the VMS to the video camera IP address.

In another aspect of a particular embodiment the method further includes establishing video contact between the remote client and the MVD through the VMS. In another aspect of a particular embodiment the MVD further comprises a mobile video audio device (MVAD), the method further includes establishing audio contact between the remote client and emergency personnel associated with the MVAD through the VMS.

In another particular embodiment a computer readable medium containing a computer program for sending video data over an internet protocol (IPTV) network is disclosed. The computer program includes instructions to receive an emergency call from a remote client IPTV device over the IPTV network at a video monitoring system (VMS), instructions to receive over the IPTV network at VMS video data from video camera at the remote client, instructions to locate a mobile video device (MVD) proximate of the remote client; and instructions to send the video data to the MVD. In another aspect of a particular embodiment the computer program further includes instructions to receive an IP address for the video camera, instructions to accept video control commands for the video camera from the MVD at the VMS and instructions to send data representing the video control commands from emergency personnel associated with the MVD to the IP address for the video camera. In another aspect of a particular embodiment the computer program further includes instructions to send video data from the MVD to the remote client through the VMS.

In another aspect of a particular embodiment the MVD is a mobile video audio device (MVAD), the computer program further includes instructions to establish audio communication between the remote client and the MVAD through the VMS.

In another particular embodiment a computer readable medium containing a computer program for sending video data over an internet protocol (IPTV) network is disclosed. The computer program instructions to receive an emergency call from a remote client IPTV device through the IPTV network at a mobile video device (MVD) and instructions to receive at the MVD, video data through the VMS from a video camera associated with the remote control. In another aspect of a particular embodiment the computer program further includes instructions to receive an IP address for a video camera from a video monitoring system (VMS) at the remote client and instructions to send video control commands data from the MVD through the VMS to the video camera IP address. In another aspect of a particular embodiment the computer program further includes instructions to establish video contact between the remote client and the MVD through the VMS. In another aspect of a particular embodiment the MVD further comprises a mobile video audio device (MVAD), the computer program further includes instructions to establish audio contact between the remote client and the MVAD through the VMS.

In another particular embodiment a data structure in memory is disclosed. The data structure includes an STB identifier field for storing data indicative of a set top box (STB) identifier, a camera ID and IP address field for containing data indicative of camera identifiers (ID) and IP addresses within a residence associated with the STB, an STB physical location and address field for storing data indicative of a STB physical location and address for correlation by a geographical information system to find a mobile video audio device address proximate of the residence and a mobile video audio device (MVAD) address field for storing data indicative of a MVAD ID and address for communication of video and audio data between the MVAD and the STB located at residence.

In another aspect of a particular embodiment the data structure further includes a house layout field for storing data indicative of a house layout showing room locations, camera ID and locations, speaker IDs and locations, and display IDs, IP addresses and locations within residence. In another aspect of a particular embodiment the data structure further includes a speaker ID and IP address field for storing data indicative of a speaker ID and IP address within residence. In another aspect of a particular embodiment the data structure further includes an MVAD ID field for containing data indicative of a MVAD ID and IP address proximate of the residence for audio and video communication between the MVAD and the cameras, microphones, speakers, and displays within the residence.

In another particular embodiment a mobile video device is disclosed. The mobile video device includes a processor coupled to memory and a computer program stored in the memory, the computer program including instructions to receive an emergency call from a remote client IPTV device through a VMS in the IPTV network at mobile video device (MVD) and instructions to receive at the MVD, video data through the VMS from a video camera at the remote client.

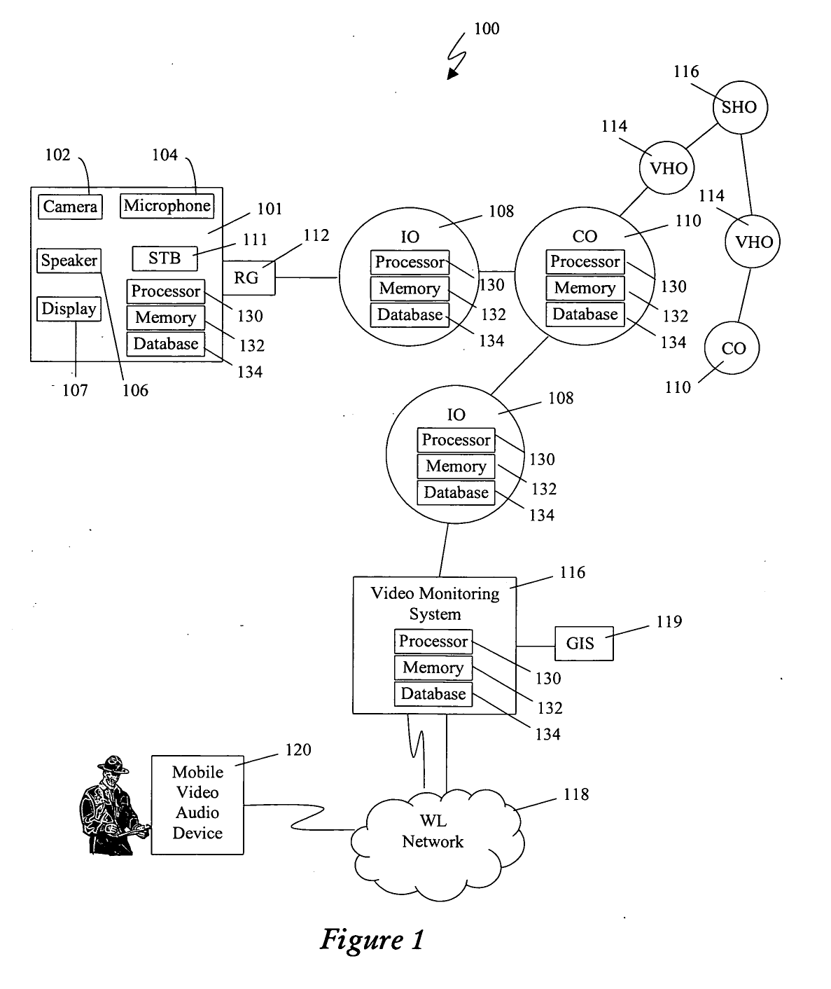

Turning now to FIG. 1 in an illustrative embodiment an internet protocol television (IPTV) network 100 is utilized as a transport mechanism for video and audio data between a residence 101 through a video monitoring system (VMS) to a mobile video audio device (MVAD) 120. Audio data communication and video data communication between the residence 101 and MVAD 120 is accomplished via the internet protocol television network through the video monitoring system (VMS) 116 and wireless network 118. As shown in FIG. 1 in an illustrative embodiment the IPTV network 100 comprises a super head end (SHO) 116 which streams video and audio data from the SHO to regional video head ends (VHOs) 114. Each regional VHO 114 streams audio and video data to central offices (COs) 110. Each CO streams audio and video data to the intermediate offices (IOs) 108.

Each IO 108 sends video and audio data to individual client set top boxes (STBs) 111 by sending video and audio data to and from each client STB 111 via a network interface device or gateway such as a residential gateway 112. Each IO communicates between the IO and residence STB sending video and audio data, as well as command and control data including IP addresses for IP devices within the residence. Data can be transmitted between the IO 108 and the STB 111 including video audio data and command and control data. The STB 111 includes processor 130, memory 132, and database 134. Processor 130 is in data communication with memory 132. Programming instructions including computer programs can be stored in memory 132 for execution by processor 130. Database 134 includes stored data and data structures containing stored data utilized in an illustrative embodiment. The STB 111 in an illustrative embodiment is located at a residence 101.

The residence 101 includes various security monitoring IP devices such as camera 102, microphone 104, speaker 106, and display 107. Video and audio data can be collected at the residence via camera 102 and microphone 104 and transmitted via the STB 111 through an IP interface such as a residential gateway 112 to the IO 108 and on to a CO 110, second IO 108, VMS 116 and MVAD 120.

The video and audio data can be communicated from the residence 101 to a CO 110 to another intermediate office 108 and therefrom to a video monitoring system 116 and MVAD 120. The video monitoring system (VMS) 116, IO 108, CO 110, VHO 114, SHO 116 and MVAD 120 each include a processor 130, memory 132, and database 134. Processor 130 is in data communication with memory 132. Programming instructions including computer programs can be stored in memory 132 for execution by processor 130. Database 134 includes data and data structures utilized in an illustrative embodiment.

Video data and audio data transmitted to the MVS 116 can be forwarded via wireless network 118 to a mobile video audio device approximate of residence 101. Mobile video audio devices 120 are tracked using a global position system (GPS) or geographic information system (GIS) by video monitoring system 116 and their locations stored in database 134 at video monitoring system 116 in VMS database 134. A set top box (STB) identifier is communicated to the VMS associated with residence 101 and used as input to geographical information system (GIS) 119. The locations of tracked mobile video audio devices 120 are input to the GIS to locate a MVAD 120 proximate of residence 101 when an emergency call response is performed from outside the residence. Thus a MVAD 120 proximate of the residence 101 can be located so that audio and video surveillance of the residence 101 can be carried out by emergency personnel without entering the residence 101. Control of the camera 102 at residence 101 can be performed by emergency personnel external to the residence by a MVAD 120. The MVAD can also be used to establish video and audio communications between the mobile video audio device 120 and residence 101. Thus emergency personnel outside of residence 101 can see and hear inside of residence 101 and carry on two-way video and audio communications within residence 101 from outside of residence 101 via mobile video audio device 120. In another particular embodiment the MVAD may also transmit or receive audio or video data only.

The video and audio data along with command and control information data for cameras at the residence 101 is sent from the MVAD through the wireless network 118 to the IPTV system 100 IO 108. The IPTV system 100 routes the MVAD video, encapsulates and sends audio and command and control data from the MVAD 120 through the VMS 116 to the IO 116, CO 110 to the RG 112 and STB 111 via the IO 108. The STB 111 receives the data from the RG 112. The camera command and control data includes pitch zoom and tilt commands issued from the MVAD. The MVAD may also be a video only device or mobile video device (MVD).

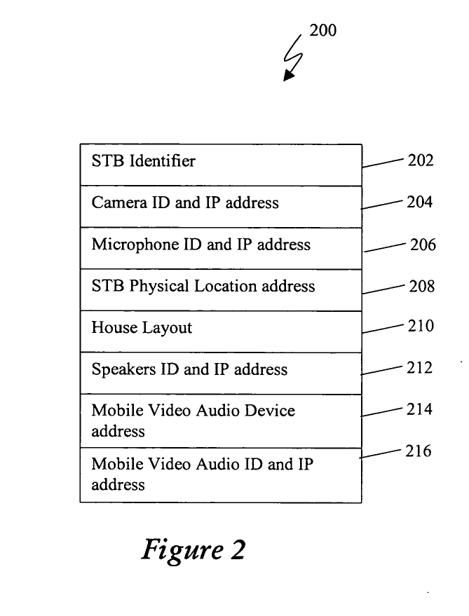

Turning now to FIG. 2 a data structure as used in an illustrative embodiment is depicted. The data structure 200 includes but is not limited to a STB identifier field for containing data indicative of a set top box (STB) identifier 202 at the residence. A camera ID and IP address field 204 is included in data structure 200 for containing data indicative of camera identifiers (ID) and IP addresses within residence 101. A microphone IP address field 206 is included in data structure 200 for containing data indicative of a microphone ID and IP address within residence 101. A STB physical location and address field 208 is included in data structure 200 for storing data indicative of a set top box physical location and address for correlation by the geographical information system 119 to find a proximate MVAD 120 address. The VMS keeps track of MVAD locations in VMS database 134. The residence address and MVAD locations are sent to the GIS 119 to determine the MVAD closest to or proximate of the residence 101. A house layout field 210 is included in data structure 200 for storing data indicative of a house layout showing room locations, camera ID and locations, speaker IDs and locations, and display IDs, IP addresses and locations within each room of the residence 101. The house layout field data can be sent to the MVAD and used to locate audio and video devices in the residence to communicate audio and video data between the MVAD 120 and the residence 101 in various rooms of the house as shown in the house layout. A speaker ID and IP address field 212 is included in data structure 200 for storing data indicative of a speaker 106 ID and IP address within residence 101. A mobile video audio device address 214 is included in data structure 200 for storing data indicative of a MVAD ID and address for communication of video and audio data between the MVAD and the STB 110 located at residence 101. A MVAD ID field 216 is included for containing data indicative of a MVAD ID and IP address proximate of the residence 101 for audio and video communication between the MVAD and the cameras, microphones, speakers, and displays within the residence 101.

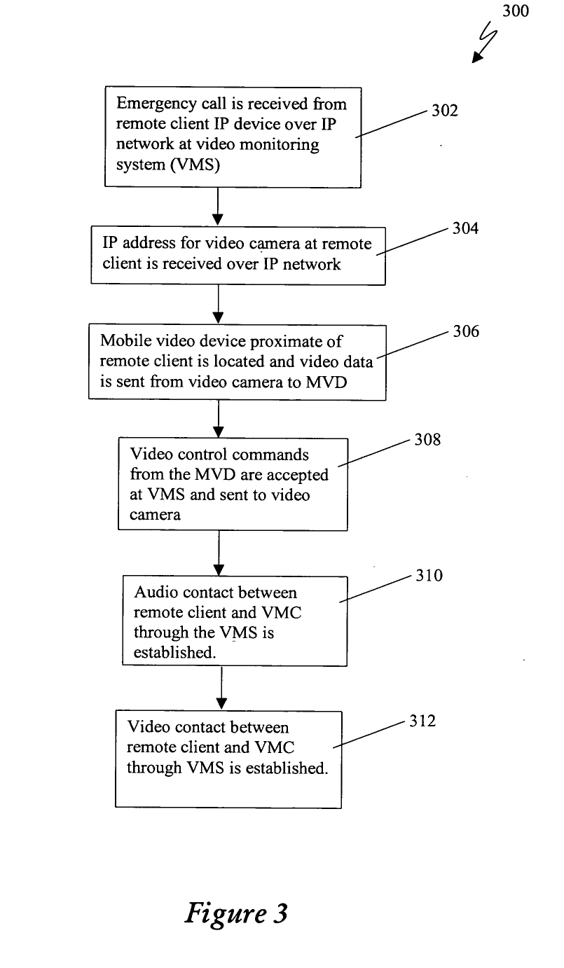

Turning now to FIG. 3, FIG. 3 is a flowchart depicting a method for sending video data over an internet protocol (IP) network. An emergency call is received from the remote client (residence STB) IP device over the IP (e.g., IPTV) network at the VMS 116 at 302. The IP address for the video camera at the remote client is received over the IP network at 304. The MVAD proximate of the remote client (residence STB) is located and the video data is sent from the video camera to the MVAD at 306. The video control commands from the MVAD are accepted at the VMS and sent to video camera at 308. The audio contact between the remote client (STB 111) and MVAD through the VMS is established at 310. The video contact between the remote client and the MVAD through the VMS is established at 312.

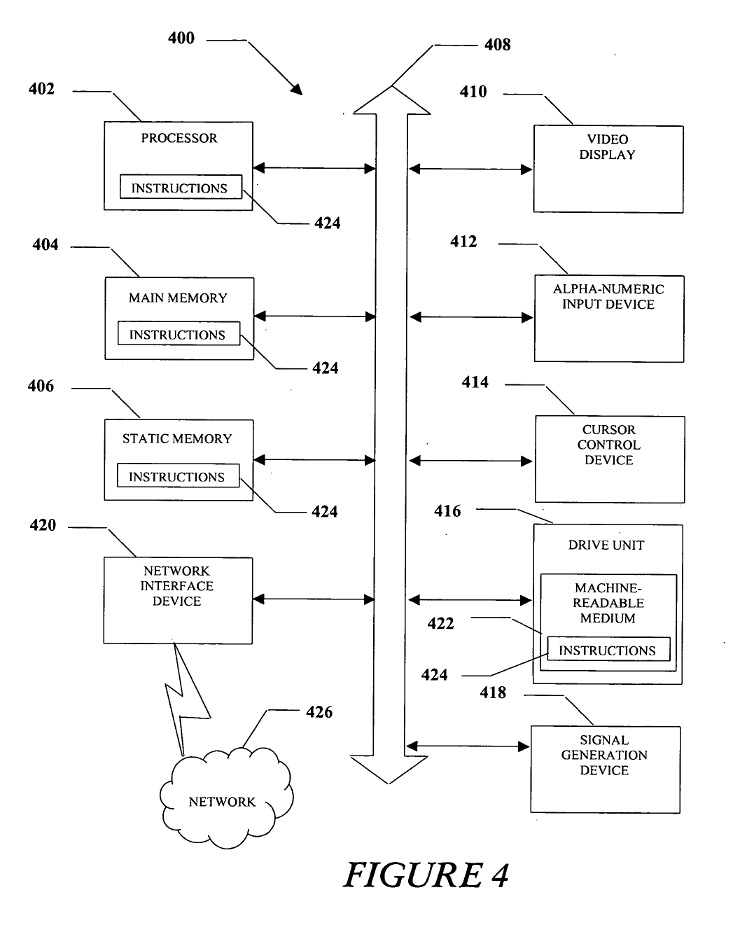

Turning now to FIG. 4, the computer system 400 may include a processor 402 (e.g., a central processing unit (CPU), a graphics processing unit (GPU), or both), a main memory 404 and a static memory 406, which communicate with each other via a bus 408. The computer system 400 may further include a video display unit 410 (e.g., liquid crystals display (LCD), a flat panel, a solid state display, or a cathode ray tube (CRT)). The computer system 400 may include an input device 412 (e.g., a keyboard), a cursor control device 414 (e.g., a mouse), a disk drive unit 416, a signal generation device 418 (e.g., a speaker or remote control) and a network interface device 420.

The disk drive unit 416 may include a machine-readable medium 422 on which is stored one or more sets of instructions (e.g., software 424) embodying any one or more of the methodologies or functions described herein, including those methods illustrated in herein above. The instructions 424 may also reside, completely or at least partially, within the main memory 404, the static memory 406, and/or within the processor 402 during execution thereof by the computer system 400. The main memory 404 and the processor 402 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the illustrative embodiment, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The illustrative embodiment contemplates a machine readable medium containing instructions 424, or that which receives and executes instructions 424 from a propagated signal so that a device connected to a network environment 426 can send or receive voice, video or data, and to communicate over the network 426 using the instructions 424. The instructions 424 may further be transmitted or received over a network 426 via the network interface device 420.

While the machine-readable medium 422 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the illustrative embodiment. The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the illustrative embodiment is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the illustrative embodiment is not limited to such standards and protocols. Each of the standards for Internet and other packet switched network transmission (e.g., TCP/IP, UDP/IP, HTML, and HTTP) represent examples of the state of the art. Such standards are periodically superseded by faster or more efficient equivalents having essentially the same functions. Accordingly, replacement standards and protocols having the same functions are considered equivalents.

What is claimed is:

1. A method for sending video data over an internet protocol (IPTV) network, comprising:
receiving an emergency call from a remote client IPTV device over the IPTV network at a video monitoring system (VMS);
receiving over the IPTV network at the VMS video data from a video camera at the remote client;
locating a mobile video device (MVD) proximate to the remote client; and
sending the video data to the MVD.

2. The method of claim 1, wherein the emergency call is a 911 call.

3. The method of claim 1, further comprising:
receiving an internet protocol (IP) address for the video camera;
accepting video control commands from emergency personnel associated with the MVD for the video camera from the MVD at the VMS; and
sending data indicating the video control commands to the IP address for the video camera.

4. The method of claim 1, further comprising:
sending video data from the MVD to the remote client through the VMS.

5. The method of claim 1, wherein the MVD further comprises a mobile video audio device (MVAD), the method further comprising:
establishing audio communication between the remote client and emergency personnel associated with the MVAD through the VMS.

6. A method for receiving video data over an internet protocol (IPTV) network, comprising:
receiving an emergency call from a remote client IPTV device through a VMS in the IPTV network at mobile video device (MVD); and
receiving at the MVD, video data through the VMS from a video camera at the remote client.

7. The method of claim 6, further comprising:
receiving an IP address for the video camera from a video monitoring system (VMS) at the remote client; and
sending video control commands data from the MVD through the VMS to the video camera IP address.

8. The method of claim 6, further comprising:
establishing video contact between the remote client and the MVD through the VMS.

9. The method of claim 6, wherein the MVD further comprises a mobile video audio device (MVAD), the method further comprising:
establishing audio contact between the remote client and emergency personnel associated with the MVAD through the VMS.

10. A computer readable medium, containing a computer program for sending video data over an internet protocol (IPTV) network, the computer comprising:
instructions to receive an emergency call from a remote client IPTV device over the IPTV network at a video monitoring system (VMS), instructions to receive over the IPTV network at VMS video data from a video camera at the remote client, instructions to locate a mobile video device (MVD) proximate of the remote client, and instructions to send the video data to the MVD.

11. The medium of claim 10, the computer program further comprising:
instructions to receive an internet protocol (IP) address for the video camera, instructions to accept video control commands for the video camera from the MVD at the VMS, and instructions to send data representing the video control commands from emergency personnel associated with the MVD to the IP address for the video camera.

12. The medium of claim 10, the computer program further comprising:
instructions to send video data from the MVD to the remote client through the VMS.

13. The medium of claim 10, wherein the MVD further comprises a mobile video audio device (MVAD), the computer program further comprising:
instructions to establish audio communication between the remote client and the MVAD through the VMS.

15. A computer readable medium containing a computer program for sending video data over an internet protocol (IPTV) network, the computer program comprising:
instructions to receive an emergency call from a remote client IPTV device through a VMS in the IPTV network at a mobile video device (MVD); and
instructions to receive at the MVD, video data through the VMS from a video camera associated with the remote client.

16. The medium of claim 15, the computer program further comprising:
instructions to receive an IP address for the video camera from a video monitoring system (VMS) at the remote client; and
instructions to send video control commands data from the MVD through the VMS to the video camera IP address.

17. The medium of claim 15, the computer program further comprising:
instructions to establish video contact between the remote client and the MVD through the VMS.

18. The medium of claim 15, wherein the MVD further comprises a mobile video audio device (MVAD), the computer program further comprising:
instructions to establish audio contact between the remote client and the MVAD through the VMS.

19. A data structure in memory, the data structure comprising:
an STB identifier field for storing data indicative of a set top box (STB) identifier;
a camera ID and IP address field for containing data indicative of camera identifiers (ID) and IP addresses within a residence associated with the STB; and
an STB physical location and address field for storing data indicative of a STB physical location and address for correlation by a geographical information system to find a mobile video audio device address proximate of the residence; and
a mobile video audio device (MVAD) address field for storing data indicative of a MVAD ID and address for communication of video and audio data between the MVAD and the STB located at residence.

20. The data structure of claim 19, the data structure further comprising:
a house layout field for storing data indicative of a house layout showing room locations, camera ID and locations, speaker IDs and locations, and display IDs, IP addresses and locations within residence.

21. The data structure of claim 19, the data structure further comprising:
a speaker ID and IP address field for storing data indicative of a speaker ID and IP address within residence.

22. The data structure of claim 19, the data structure further comprising:
an MVAD ID field for containing data indicative of a MVAD ID and IP address proximate of the residence for audio and video communication between the MVAD and the cameras, microphones, speakers, and displays within the residence.

23. A mobile video device comprising:
a processor coupled to memory; and
a computer program stored in the memory, the computer program comprising:
instructions to receive an emergency call from a remote client IPTV device through a VMS in the IPTV network at mobile video device (MVD) and instructions to receive at the MVD, video data through the VMS from a video camera at the remote client.
